(19) United States
(12) Patent Application Publication
(10) Pub. No.: US 2015/0270839 A1
(43) Pub. Date: Sep. 24, 2015

(54) Identification Circuit

(71) Applicant: SIEMENS AKTIENGESELLSCHAFT, München (DE)

(72) Inventors: Andreas Mucha, Munchen (DE); Meinrad Schienle, Ottobrunn (DE)

(21) Appl. No.: 14/428,778

(22) PCT Filed: Aug. 28, 2013
(86) PCT No.: PCT/EP2013/067839

§ 371 Date: Mar. 17, 2015

(30) Foreign Application Priority Data
Sep. 18, 2012 (DE) 10 2012 216 677.7

(51) Int. Cl. H03K 19/177; H03K 19/00; G06F 21/44

(52) U.S. Cl. CPC H03K 19/17768; G06F 21/44; H03K 19/0008

(57) ABSTRACT

An identification circuit is provided for generating a unique identification pattern for an object to be identified. The circuit includes at least one bistable closed circuit ring that includes a plurality of switching stages, each switching stage having at least two parallel internal signal delay paths, which are connected directly to one another on the input side and are selectable on the output side by at least one challenge bit of a challenge word applied to the circuit ring. Each internal signal path has a production-determined individual signal transit time, wherein a reset element which shifts a downstream switching stage temporarily into an unstable state is provided for each switching stage. The switching stages transition out of the respective unstable states on the basis of signal transit times, which may be read out as a response word that forms the unique identification pattern for the object to be identified.

### CROSS-REFERENCE TO RELATED APPLICATIONS

The present patent document is a §371 nationalization of PCT Application Serial Number PCT/EP2013/067839, filed Aug. 28, 2013, designating the United States, which is hereby incorporated by reference, and this patent document also claims the benefit of DE 10 2012 216 677.7, filed on Sep. 18, 2012, which is also hereby incorporated by reference.

### TECHNICAL FIELD

The embodiments relate to an identification circuit for producing an explicit identification pattern for an object that is to be identified.

### BACKGROUND

In many instances of application, it is desirable and/or necessary to explicitly identify a physical object. By way of example, objects that are produced may be marked in order to allow an object to be associated with a production batch in the event of technical defects arising on the object. By way of example, in the case of an authentication process, it is desirable to provide that an object is actually the expected object.

In order to identify objects, it is possible to use what are known as physical unclonable functions (PUF). Such PUFs involve complex behavior of a physical system or object being utilized that is determined by factors that are directly observable, influenceable or reproducible neither by the producer of the object nor by anyone else, for example, an attacker. A PUF is a function that maps input values, (e.g., what is known as a challenge word), onto output values, (e.g., what is known as a response word), on the basis of a complex physical process within the PUF structure. In this case, this mapping of challenges onto responses is different, and hence for practical purposes random, for every physical specimen or instance of the object. PUF functions may therefore be used for security applications, for example, and form challenge/response pairs CRP. Providing that the number of possible challenge/response pairs CRP that are provided by a PUF function is large enough for it to be infeasible for an attacker to find out a significant proportion of the challenge/response pairs, even if the attacker has physical access to the respective object, this is referred to as a strong PUF function. In this case, by way of example, an authenticating party may select a known challenge from a list of previously stored challenge/response pairs CPR, send it to the PUF structure, and compare the response returned by the PUF structure with the stored response. If the two values match, the sought object is genuine or identified.

In one possible embodiment of conventional PUF structures, a bistable ring of inverters, as depicted in FIG. 1, is used. In the case of a PUF structure that contains a bistable ring (bistable ring PUF), an even number of inverter circuits is connected up in a closed ring. On account of the even number of inverters, the bistable ring has two possible stable states. The closed ring of inverters has two stable states, that is to say beginning at an arbitrarily permanently chosen stage of the ring it is possible for the outputs of the connected inverters to have either the pattern “0101 . . . ” or alternatively the pattern “1010 . . . . ” The random variations, dependent on the production of the closed ring, in the properties of circuits integrated therein and of the elements of the circuits influence which of the two stable states the respective closed ring adopts in the case of each physical specimen or instance of a BR-PUF. This information concerning which of the two states is present corresponds to a PUF-response of 1 bit that represents the two possible stable states. A PUF circuit that is based on a bistable ring (bistable ring PUF) has the disadvantage that each bistable ring supplies just 1 bit of information for identifying the object. Therefore, Chen et al.: “The Bistable Ring PUF, a new architecture for strong Physical Unclonable Functions”, 2011 IEEE International Symposium on Hardware-Oriented Security and Trust (HOST), 134-141, has proposed a PUF circuit in which a bistable ring includes circuit elements, as is depicted in FIG. 2. This produces a bistable circuit ring including an arrangement having an even number of digital circuit stages that implement logic negation, with inputs and outputs of the circuit stages being connected up to one another such that the closed ring is obtained. As may be seen from FIG. 2, the conventional switching stage used in this case has two parallel-connected NOR gates that each implement logic negation. The conventional switching stage depicted in FIG. 2 has a demultiplexer on the input side and a multiplexer on the output side, each being actuated by 1 bit of an applied challenge word and being able to change over between different signal delay paths, each signal delay path containing a NOR gate. A challenge bit C[i] of the applied challenge word therefore controls which of the two signal delay paths is active. The length of the applied challenge word in bits corresponds to the number of switching stages in the closed ring, e.g., each bit of the challenge word determines the configuration of the signal path within a switching stage. In order to allow repeated reading of the response word R after a new challenge word C has been applied, the negations are each implemented by a NOR gate having two inputs, one of the inputs of the NOR gate being connected to a reset signal line for the purpose of applying a reset signal (Reset). When the reset signal is at logic high, all outputs of the NOR gates are at logic low and the closed ring is in an unstable state. If the reset signal falls to logic low (0), the NOR gates operate as inverters for the other input and the ring returns to one of the two stable states after a certain transient time.

The conventional identification circuit with a closed circuit ring that is made up of conventional switching stages that each have the design depicted in FIG. 2 has the disadvantage, however, that each switching stage has a demultiplexer on the input side, the demultiplexer leading to a relatively large amount of surface area being used up for integration in an integrated circuit, for example. Furthermore, the conventional switching stage depicted in FIG. 2 requires a NOR gate with a reset function for each signal path, which undesirably increases the total surface area used up for integration.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the present embodiments to provide an identification circuit for producing an explicit identification pattern for an object that is to be identified that uses up minimal surface area for integration.

An identification circuit is provided for producing an explicit identification pattern for an object that is to be identified, including at least one bistable closed circuit ring that includes a plurality of switching stages. Each switching stage of the circuit ring has at least two parallel internal signal delay paths, the input sides of which are connected to one another directly and the output sides of which may be selected by at least one challenge bit of a challenge word applied to the circuit ring. Each internal signal delay path of the switching stage has a manufacture-dependent individual signal propagation time. Each switching stage of the circuit ring has a respective reset element provided for it that puts a downstream switching stage temporarily into an unstable state. The switching stages of the circuit ring change from their respective unstable states to stable states on the basis of the signal propagation times selected by the applied challenge word, the stable states being able to be read as a response word that forms the explicit identification pattern for the object.

The identification circuit has the advantage that it offers a particularly high level of information density for the explicit identification of an object that is to be identified, for example, in the case of integration on a chip.

A further advantage of the identification circuit is that the circuit has particularly low energy or power consumption during operation on account of the relatively low circuit complexity.

In one possible embodiment of the identification circuit, each switching stage of the closed circuit ring has a selection element for selecting an internal signal path on the basis of at least one challenge bit of the applied challenge word.

In a further possible embodiment of the identification circuit, the internal signal delay paths of the different switching stages of the closed circuit ring have delay elements that each bring about a particular signal transit time.

In a further possible embodiment of the identification circuit, at least some of the switching stages within the closed circuit ring each have at least one negation element that outputs the logic value applied to an input of the switching stage in negated form at an output of the switching stage.

In one possible embodiment of the identification circuit, the number of series-connected negation elements within a switching stage is uneven.

In one possible embodiment of the identification circuit, the sum of series-connected negation elements from all switching stages within the closed circuit ring is even.

In one possible embodiment of the identification circuit, the at least one negation element of a switching stage is provided in each of the parallel signal delay paths of the switching stage.

In one possible embodiment of the identification circuit, the at least one negation element of a switching stage is provided in the reset element of the switching stage.

In a further possible embodiment of the identification circuit, the at least one negation element of the switching stage is provided in the selection element of the switching stage.

In a further possible embodiment of the identification circuit, the reset element is a logic gate that logically combines a reset signal with an output signal from the selection element.

In a further possible embodiment of the identification circuit, the reset element is a pull-down transistor that pulls an output of the selection element to a logic low value when a reset signal is applied.

In a further alternative embodiment of the identification circuit, the reset element is a pull-up transistor that pulls an output of the selection element to a logic high value when a reset signal is applied.

In a further possible embodiment of the identification circuit, the selection element of a switching stage is a multiplexer.

In a further alternative embodiment of the identification circuit, the selection element of the switching stage is formed by one tri-state gate in each of the parallel signal paths.

In a further possible embodiment of the identification circuit ac, a transformation circuit is provided that converts an applied challenge word into control signals that are applied to the selection elements of the switching stages of the closed circuit ring.

In one possible embodiment of the identification circuit, the identification circuit is nondetachably connected to the object that is to be identified.

In one possible embodiment of the identification circuit, the identification circuit is integrated in the object that is to be identified.

In one possible embodiment of the identification circuit, the object that is to be identified is an integrated circuit that has the identification circuit integrated in it.

An integrated circuit is also provided, the integrated circuit including an identification circuit integrated therein for the purpose of identifying the respective circuit.

An identification tag is also provided for identifying a physical object, the identification tag including an identification circuit for producing an explicit identification pattern for the object that is to be identified and having a transceiver that receives the challenge word and returns the response word as an identification pattern for the purpose of identifying the object that is to be identified.

### BRIEF DESCRIPTION OF THE DRAWINGS

Possible exemplary embodiments of the identification circuit for producing an explicit identification pattern for an object that is to be identified are explained in more detail below with reference to the appended figures.

FIG. 1 depicts a circuit diagram to illustrate a commercial PUF circuit having a closed bistable ring, BR-PUF, according to the prior art.

FIG. 2 depicts a circuit diagram to illustrate a switching stage of a bistable and closed circuit ring for a conventional identification circuit according to the prior art.

FIG. 3 depicts a block diagram to illustrate an exemplary embodiment of an identification circuit.

FIG. 4 depicts an exemplary embodiment to illustrate a switching stage of a bistable closed circuit ring that may be used for the identification circuit.

FIG. 5 depicts a further exemplary embodiment of a switching stage within a closed circuit ring, as may be used for the identification circuit.

FIG. 6 depicts a diagram to illustrate a further exemplary embodiment of a switching stage for a possible embodiment of the identification circuit.

FIG. 7 depicts a diagram to illustrate a further exemplary embodiment of a switching stage within a bistable closed circuit ring for a possible embodiment of the identification circuit.

FIG. 8 depicts a further exemplary embodiment of a switching stage within a bistable closed circuit ring for a further embodiment of the identification circuit.

FIG. 9 depicts a further exemplary embodiment of a switching stage within a bistable closed circuit ring for a further embodiment of the identification circuit.

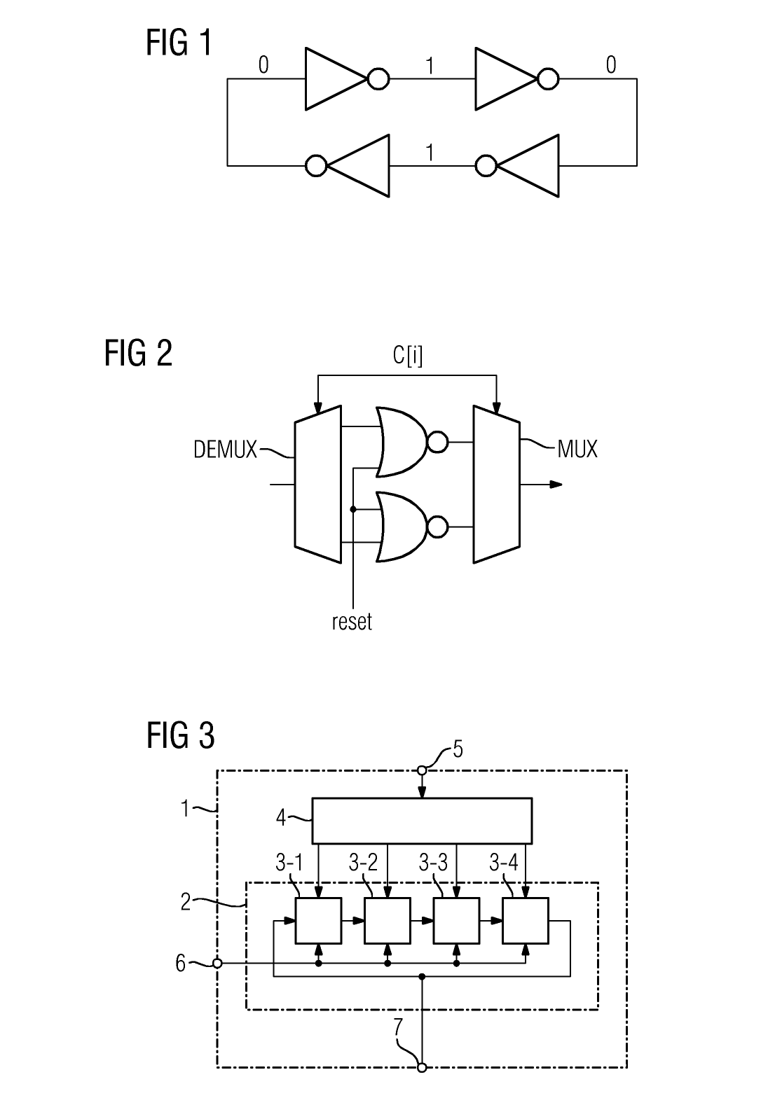

### DETAILED DESCRIPTION

As may be seen from FIG. 3, an identification circuit 1 in the exemplary embodiment depicted has at least one circuit ring 2. The identification circuit 1 is used to produce an explicit identification pattern for an object that is to be identified, particularly a physical object that is to be identified. In this case, the identification circuit 1 may be nondetachably connected to the object that is to be identified. In one possible embodiment, the object that is to be identified is an integrated circuit that, besides other circuit elements, also contains an identification circuit 1 that produces or generates an identification pattern for explicitly identifying the respective integrated circuit. The circuit ring 2 is a closed circuit ring that has a plurality of switching stages 3-1, 3-2, 3-3, 3-4. The number of switching stages 3-i in the closed bistable circuit ring 2 may correspond to the number of challenge bits in a challenge word C applied to the closed circuit ring 2. In one possible embodiment, this challenge word C may be applied to the bistable closed circuit ring 2 directly. In the exemplary embodiment depicted in FIG. 3, the identification circuit 1 additionally has a transformation circuit 4 that converts a challenge word C applied to an input 5 of the identification circuit 1 into control signals or an internal challenge word, the challenge bits C[i] of which are applied to the switching stages 3-i of the bistable closed circuit ring 2, as depicted in FIG. 3. Each switching stage 3-i of the bistable closed circuit ring 2 is connected to a reset line that is connected to a reset input 6 of the identification circuit 1. In addition, at one point in the closed circuit ring 2 it is possible to tap off a response bit of a response word and to output it at an output 7 of the identification circuit 1. In the exemplary embodiment depicted in FIG. 3, the identification circuit 1 has one bistable closed circuit ring 2. In an alternative embodiment, the identification circuit 1 may also contain a plurality of closed circuit rings 2. In one possible embodiment, the challenge word may be received externally. In a possible alternative embodiment, the challenge word C that is applied to the input 5 of the identification circuit 1 may be generated by a generator of the object that is to be identified itself, for example, when the object that is to be identified is an integrated circuit or the like. The response bits delivered by the bistable closed circuit rings 2 are compiled to form a response word R that forms an explicit identification pattern for the respective object. In one possible embodiment, this identification pattern may be output in order to identify the respective object.

In the identification circuit, the switching stage 3-i of the closed circuit ring 2 has at least two parallel internal signal delay paths. The input sides of these signal delay paths are connected to one another directly within the respective switching stage 3-i. The outputs of the internal signal delay paths may be selected by at least one challenge bit C[i] of the challenge word C. The internal signal path within a switching stage 3-i of the closed circuit ring 2 has a manufacture-dependent individual signal propagation time. Each switching stage 3-i of the closed circuit ring 2 has a reset element provided for it that puts a downstream switching stage (3-i)+1 of the circuit ring 2 temporarily into an unstable state. The switching stages 3-i of the closed circuit ring 2 change over from their respective unstable states to stable states on the basis of the signal path selected by the applied challenge word C. In this case, the closed circuit ring 2 has two stable states, which have a first signal pattern “1010 . . . ” or a second signal pattern “0101 . . . ” Which of the two stable states the circuit ring 2 adopts is dependent on the challenge word C and on the manufacture-dependent individual signal propagation times selected thereby for the switching stages within the closed circuit ring 2. Each switching stage 3-i of the closed circuit ring 2 contains a selection element for selecting an internal signal delay path on the basis of at least one challenge bit of the applied challenge word C. In one possible embodiment, the selection element is a multiplexer. In an alternative embodiment, the selection element is formed by one tri-state gate in each of the parallel signal paths. Instead of using a multiplexer, the selection element may also be implemented in distributed fashion, for example, if there are other devices providing that only one of the parallel signal delay paths drives the next switching stage. By way of example, it is possible, when logic gates with a deactivatable output are used, to use what are known as tri-state gates, as is the case in the exemplary embodiment depicted in FIG. 6, for example. In one possible embodiment, the internal signal delay paths of the different switching stages 3-i of the closed circuit ring 2 include delay elements that each bring about a particular signal propagation time. This makes it possible to bring about an additional signal delay as a result of gates additionally inserted in the signal delay path. The additional gates also increase the statistical variation in the properties of the respective switching stage 3-i, so that different PUF specimens for the same challenge or different challenges for the same PUF specimen have a high probability of producing various responses and hence the PUF function becomes more explicit. In one embodiment, the internal signal delay paths of the different switching stages 3-i contain independent delay elements. Alternatively, the signal delay is implemented intrinsically by the remainder of the gates and/or lines in the switching stage. In the identification circuit 1, at least some of the switching stages 3-i within the closed circuit ring 2 are designed such that they each have at least one negation element. The negation element outputs the logic value applied to an input of the respective switching stage 3-i in negated form to the output of the switching stage. In this case, the number of series-connected negation elements in one of the parallel-connected signal delay paths within a switching stage 3-i may be uneven. By contrast, the sum of series-connected negation elements from all switching stages of the closed switching ring 2 is even. In one possible implementation, each signal delay path within a switching stage 3-i has a respective negation element and the sum of all series-connected negation elements of all switching stages in the switching ring 2 is even.

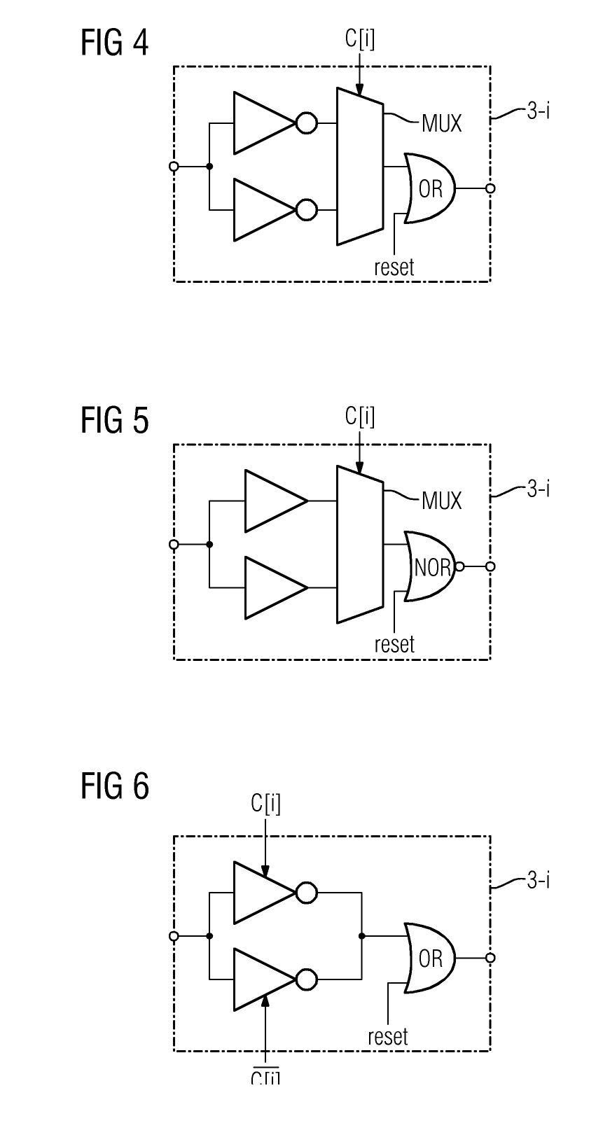

The switching stage 3-i of the closed switching ring 2 is connected to an internal reset line. The reset element within each switching stage 3-i is provided for the purpose of putting the respectively downstream switching stage 3-(i+1) of the circuit ring 2 temporarily into an unstable state. The switching stage 3-i has a reset element. If there is no longer a reset signal on the switching stages, the switching stages 3-i of the circuit ring 2 may change over from their respective unstable states to one of the two bistable states of the closed circuit ring 2 on the basis of the signal propagation times selected by the applied challenge word C. In one embodiment, the at least one negation element of a switching stage 3-i is provided in the parallel signal delay paths of the switching stage 3-i, as depicted in the exemplary embodiments depicted in FIGS. 4, 6, and 7, for example. In an alternative embodiment, the at least one negation element of a switching stage 3-i is provided in the reset element of the switching stage 3-i, as in the exemplary embodiments depicted in FIGS. 5 and 9, for example. In addition, it is possible for the negation element of a switching stage 3-i to be provided in the selection element of the respective switching stage.

In one possible embodiment, the reset element of the switching stage 3-i is a logic gate that logically combines a reset signal with an output signal from the selection element. The embodiments depicted in FIGS. 4, 5, 6, 8, and 9 each have, as reset elements, a logic gate that logically combines a reset signal with an output signal from the selection element of the respective switching stage 3-i.

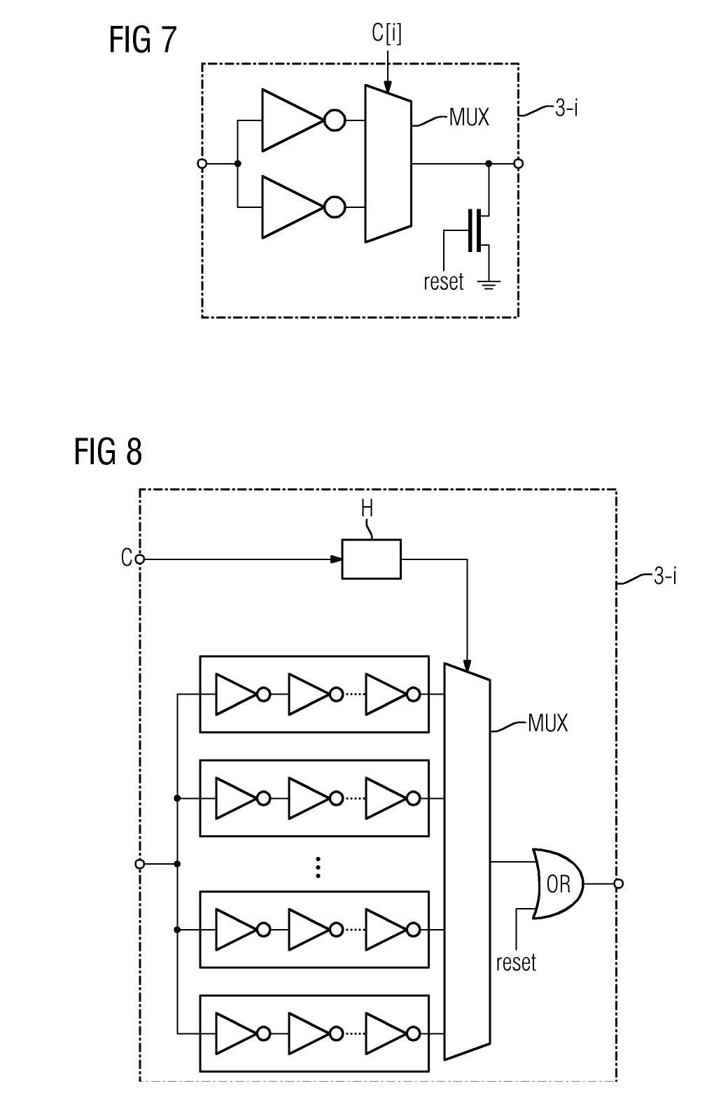

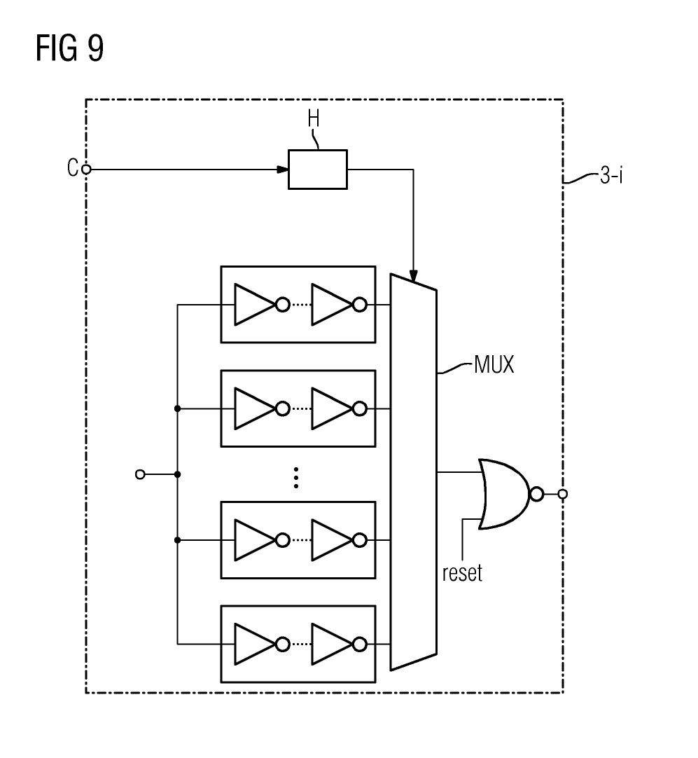

In an alternative embodiment, the reset element may also be a transistor, for example, a bipolar or field effect transistor. By way of example, the reset element may be a pull-down transistor that pulls a signal output of the selection element to a logic low value or level when the reset signal is applied. By way of example, the exemplary embodiment depicted in FIG. 7 has a pull-down NMOS transistor that pulls the signal output of a multiplexer in the switching stage 3-i, which multiplexer forms the selection element, to a logic low signal level or ground by applying a logic high reset signal. In this case, the pull-down transistor forms, to a certain extent, a switch that takes the reset signal as a basis for pulling the signal output of the multiplexer to the low signal level. Alternatively, in a further embodiment, instead of a pull-down transistor it is also possible to use a pull-up transistor, which pulls a signal output of the selection element to a logic high value or signal level when a logic high reset signal is applied.

The pull-up transistor may be a PMOS that is actuated with an inverse reset signal. (Reset signal logic low 4 signal output is pulled to logic high)

In one possible embodiment, each switching stage 3-i of the bistable closed circuit ring 2 has different functional elements, namely: (1) a selection element that routes the transiting signal via one or more signal delay paths; (2) a signal delay element that brings about a certain transit time; (3) a negation element that forwards the logic value applied to the input to the output of the switching stage in negated form; and (4) a reset element that allows the closed circuit ring 2 to be temporarily put into an unstable state. The functions of the closed bistable circuit ring 2 may be achieved by a large number of different circuit implementations, the switching stages 3-i each containing the aforementioned functional elements. In this case, it is also possible for a plurality of functions to be provided by a circuit element or gate simultaneously. By way of example, each logic gate is subject to a certain intrinsic signal transit time and therefore provides a signal delay as an additional function. In addition, every single one of the aforementioned functions may be provided in distributed fashion by a plurality of circuit elements.

FIG. 4 depicts a first possible implementation of a switching stage 3-i within the closed circuit ring 2. In the exemplary embodiment depicted in FIG. 4, the output side of the switching stage 3-i has a selection element in the form of a multiplexer that is controlled by a challenge bit C[i] of the applied challenge word C. The challenge bit C[i] is applied to the multiplexer, which selects which of the outputs of the two inverters provided within the switching stage 3-i is connected to the next switching stage. The two inverters are connected up in two different signal delay paths and form a negation element. The input sides of the two inverters are connected to one another directly and receive the input signal from the respective preceding switching stage directly. In the exemplary embodiment depicted in FIG. 4, the switching stage additionally contains a logic OR gate that provides the reset functionality. In the exemplary embodiment depicted, an OR gate logically ORs the output signal for the selection element MUX with the reset signal. Alternatively, an AND gate may also be used if the reset signal is active as a logic low signal level.

In the exemplary embodiment depicted in FIG. 4, the negation takes place in each of the parallel signal delay paths. Alternatively, the negation may also occur at another point within the switching stage 3-i, for example, at the reset element.

FIG. 5 depicts an alternative variant embodiment, wherein only signal buffers are connected in the signal delay path. The negation occurs by a NOR gate, which logically NORs the output signal from the selection element with the reset signal. In the exemplary embodiment depicted in FIG. 5, buffer circuits are provided in the two parallel-connected signal delay paths. Alternatively, it is possible to dispense with the buffer circuits if the signal delay through the input lines of the selection element MUX is sufficient.

FIG. 6 depicts a further exemplary embodiment of a switching stage 3-i within a bistable closed ring 2 of the identification circuit 1. In the exemplary embodiment depicted in FIG. 6, each switching stage 3-i of the bistable circuit ring 2 is formed by tri-state gates, the logic gates having a deactivatable output. In this case, the upper inverter in the upper signal delay path is actuated by a bit C[i] of the challenge word C, while the lower inverter is actuated by the inverted value of the challenge bit. In the exemplary embodiment depicted in FIG. 6, the downstream reset element used in the switching stage 3-i is additionally an OR gate, which performs ORing with a reset signal.

FIG. 7 depicts a further exemplary embodiment of a switching stage 3-i within a bistable closed circuit ring 2 of the identification circuit 1. In the exemplary embodiment depicted in FIG. 7, the selection element is formed by a multiplexer MUX, the output of which may be pulled to a logic low level by a pull-down transistor on the basis of a reset signal. The input side of the multiplexer MUX is connected to a plurality of signal delay paths that each have an inverter gate. The pull-down transistor pulls the output of the multiplexer MUX to a logic low signal level, (e.g., ground), when a reset signal is applied. Alternatively, connection to a pull-up transistor is also possible. This may be a field effect transistor, for example. In the exemplary embodiment depicted in FIG. 7, an NMOS transistor is used as the pull-down transistor. The variant embodiment depicted in FIG. 7 affords the advantage that it is particularly space-saving for integration.

The number of signal delay paths within a switching stage 3-1 is not limited to two parallel signal delay paths. In one possible embodiment, a switching stage 3-i within the circuit ring 2 has more than two signal delay paths, as depicted in the exemplary embodiments depicted in FIGS. 8 and 9. The number of parallel-connected signal delay paths may be 2ⁿ, where n is a natural number. By way of example, the number of parallel-connected signal delay paths may be 2, 4, 8, 16, etc. This affords the advantage that the selection element, (e.g., a multiplexer), may be actuated with a minimal number of control lines. In an alternative embodiment, the number of signal delay paths within a switching stage 3-i may also vary. By way of example, it is also possible for the number of parallel signal delay paths to be 3, 5, etc. In this case, each switching stage may have a transformation circuit integrated for it that converts the applied bits of the challenge word C into control signals that are applied to the selection element of the switching stage 3-i. In the exemplary embodiment depicted in FIG. 8, each signal delay path contains an uneven number of negation elements in the form of inverters. The number of series-connected negation elements within the switching stage 3-i is uneven. By contrast, the sum of series-connected negation elements from all switching stages 3-i in the entire closed circuit ring 2 is even in order to be able to produce an unstable state. In the exemplary embodiment depicted in FIG. 8, the signal delay is achieved by an uneven number of inverters in order to produce logic negation overall. In the exemplary embodiment depicted in FIG. 8, the downstream reset element is formed by an OR gate that logically ORs the signal from the selection element MUX with a reset signal. The challenge C may be mapped onto suitable control signals for the multiplexer MUX of the switching stage by a transformation function H. In one possible embodiment, the transformation circuit H may be implemented for all switching stages in the entire closed circuit ring 2. In a simple case, with M parallel signal paths per switching stage, the challenge C is split into non-overlapping groups of log2 (M) bits, each of these groups controlling a multiplexer MUX as a selection element. In this case, M is a power of 2.

FIG. 9 depicts a further exemplary embodiment of a switching stage 3-i of the closed circuit ring 2 within the identification circuit 1. In the exemplary embodiment depicted in FIG. 9, the number of inverters within each of the parallel signal delay paths is even and the negation takes place in the downstream reset element of the switching stage 3-i. In the exemplary embodiment depicted in FIG. 9, the reset element is formed by a NOR gate that logically NORs the output signal from the selection element MUX with the reset signal.

The identification circuit 1 may be used in a versatile manner. In one possible embodiment, the identification circuit 1 is connected to an object that is to be identified nondetachably. By way of example, the identification circuit 1 may be used for identifying an integrated circuit IC that is to be identified. In this case, the identification circuit 1 may be integrated into the integrated circuit IC together with other circuit components of the integrated circuit IC. In one possible variant embodiment, the identification circuit 1 is the challenge word C from a generator within the circuit IC that is to be identified. Alternatively, the challenge word C may also be applied to the integrated circuit IC that is to be identified externally. The identification pattern delivered by the identification circuit 1 may be output as a response from the object that is to be identified, (e.g., an integrated circuit IC), and compared with an expected response. If the output response and the expected response match, the object that is to be identified is identified.

In a further possible embodiment, the identification circuit 1 is inserted into an identification tag for identifying a physical object. The physical object may be any item, the identification tag being connected to the physical object, e.g., nondetachably connected. Besides the identification circuit 1, as depicted in FIG. 3, the identification tag may additionally have a transceiver. This transceiver uses a wireless connection to receive a challenge word C that it applies to the identification circuit 1. The identification pattern that is then produced by the identification circuit 1 or the response word R produced is subsequently returned by the transceiver via the wireless interface. As in the exemplary embodiment depicted, the identification circuit 1 may be implemented by electrical components. In an alternative embodiment of the identification circuit 1, the identification circuit is implemented by optical components. This allows the processing speed to be increased. Furthermore, an optical implementation of the identification circuit 1 is resistant to electromagnetic interference in the surroundings of the identification circuit. In one possible variant embodiment, the identification circuit 1 is formed by an integrated chip that may be connected up to further integrated circuits on a circuit board. In one possible embodiment, the identification circuit 1 is implemented using CMOS technology.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An identification circuit for producing an explicit identification pattern for an object that is to be identified, the identification circuit comprising:
at least one bistable closed circuit ring comprising a plurality of switching stages, wherein each switching stage of the circuit ring comprises at least two parallel internal signal delay paths, each internal signal delay path having a respective input side and output side, wherein the input sides of the at least two parallel internal signal delay ahs are connected to one another directly and the output sides are configured to be selected by at least one challenge bit of a challenge word applied to the circuit ring, wherein each internal signal path of each switching stage comprises a manufacture-dependent individual signal propagation time, wherein each switching stage of the circuit ring comprises a respective reset element that puts a downstream switching stage of the circuit ring temporarily into an unstable state, wherein the switching stages of the circuit ring change from respective unstable states to stable states on the basis of the signal propagation times selected by the applied challenge word, the stable states being configured to be read as a response word that forms the explicit identification pattern for the object that is to be identified.

2. The identification circuit as claimed in claim 1, wherein each switching stage of the closed circuit ring comprises a selection element for selecting an internal signal delay path on the basis of at least one challenge bit of the applied challenge word.

3. The identification circuit as claimed in claim 1, wherein the internal signal delay paths of the switching stages of the closed circuit ring have delay elements that individually bring about a respective signal transit time.

4. The identification circuit as claimed in claim 1, wherein at least a portion of the switching stages within the closed circuit ring individually comprise at least one negation element that outputs a logic value applied to an input of the respective switching stage in negated form at an output of the respective switching stage.

5. The identification circuit as claimed in claim 4, wherein a number of series-connected negation elements within a switching stage is uneven.

6. The identification circuit as claimed in claim 4, wherein a sum of series-connected negation elements from all switching stages within the closed circuit ring is even.

7. The identification circuit as claimed in claim 4, wherein the at least one negation element of a switching stage is provided in each parallel signal delay path of the parallel signal delay paths of the switching stage.

8. The identification circuit as claimed in claim 4, wherein the at least one negation element of a switching stage is provided in the reset element of the switching stage.

9. The identification circuit as claimed in claim 4, wherein the at least one negation element of a switching stage is provided in a selection element of the switching stage.

10. The identification circuit as claimed in claim 2, wherein the reset element of a switching stage is a logic gate that logically combines a reset signal with an output signal from the selection element of the switching stage.

11. The identification circuit as claimed in claim 2, wherein the reset element is a pull-down transistor that pulls an output of the selection element of the switching stage to a logic low value when a reset signal is applied, or wherein the reset element is a pull-up transistor that pulls an output of the selection element of the switching stage to a logic high value when a reset signal is applied.

12. The identification circuit as claimed in claim 2, wherein the selection element is a multiplexer (MUX) or is formed by one tri-state gate in each of the parallel signal paths.

13. The identification circuit as claimed in claim 1, wherein a transformation circuit is provided that converts the applied challenge word into control signals that are applied to selection elements of the switching stages of the closed circuit ring.

14. The identification circuit as claimed in claim 1, wherein the identification circuit is nondetachably connected to the object that is to be identified.

15. An integrated circuit comprising:
an identification circuit comprising:
at least one bistable closed circuit ring comprising a plurality of switching stages, wherein each switching stage of the circuit ring comprises at least two parallel internal signal delay paths, each internal signal delay path having a respective input side and output side,
wherein the input sides of-the at least two parallel internal signal delay paths are connected to one another directly and the output sides are configured to be selected by at least one challenge bit of a challenge word applied to the circuit ring,
wherein each internal signal path of each switching stage comprises a manufacture-dependent individual signal propagation time,
wherein each switching stage of the circuit ring comprises a respective reset element that puts a downstream switching stage of the circuit ring temporarily into an unstable state,
wherein the switching stages of the circuit ring change from respective unstable states to stable states on the basis of the signal propagation times selected by the applied challenge word, the stable states being configured to be read as a response word,
wherein the identification circuit is configured to identify the integrated circuit.

16. An identification tag for identifying a physical object that is to be identified, the identification tag comprising:
an identification circuit comprising:
at least one bistable closed circuit ring comprising a plurality of switching stages, wherein each switching stage of the circuit ring comprises at least two parallel internal signal delay paths, each internal signal delay path having a respective input side and output side,
wherein the input sides of-the at least two parallel internal signal delay paths are connected to one another directly and the output sides are configured to be selected by at least one challenge bit of a challenge word applied to the circuit ring,
wherein each internal signal path of each switching stage comprises a manufacture-dependent individual signal propagation time,
wherein each switching stage of the circuit ring comprises a respective reset element that puts a downstream switching stage of the circuit ring temporarily into an unstable state,
wherein the switching stages of the circuit ring change from respective unstable states to stable states on the basis of the signal propagation times selected by the applied challenge word, the stable states being configured to be read as a response word; and
a transceiver that receives the challenge word and returns the response word produced as an identification pattern for the purpose of identifying the physical object that is to be identified.

17. The identification circuit as claimed in claim 2, wherein the internal signal delay paths of the switching stages of the closed circuit ring have delay elements that individually bring about a respective signal transit time.

18. The identification circuit as claimed in claim 2, wherein at least a portion of the switching stages within the closed circuit ring individually comprise at least one negation element that outputs a logic value applied to an input of the respective switching stage in negated form at an output of the respective switching stage.

19. The identification circuit as claimed in claim 18, wherein the at least one negation element of a switching stage is provided in the reset element of the switching stage.

20. The identification circuit as claimed in claim 18, wherein the at least one negation element of a switching stage is provided in the selection element of the switching stage.
